(19) United States
(12) Patent Application Publication
(10) Pub. No.: US 2015/0366122 A1
(43) Pub. Date: Dec. 24, 2015

(54) MULTIFUNCTIONAL DIGGING TOOL

(71) Applicant: Enrique VERA ANDRADES, (US)

(72) Inventor: Enrique VERA ANDRADES, San Pedro de Alcantara Malaga (ES)

(21) Appl. No.: 14/431,392

(22) PCT Filed: Sep. 16, 2013
(86) PCT No.: PCT/ES2013/070640

§ 371 Date: Mar. 26, 2015

(30) Foreign Application Priority Data
Oct. 5, 2012 (ES) U 201231024

(51) Int. Cl. A01B 1/20; A01B 1/22; A01D 9/00; A01B 1/02

(52) U.S. Cl. CPC A01B 1/20; A01B 1/024; A01B 1/227; A01D 9/00; A01B 1/022

(57) ABSTRACT

The invention relates to a dual-function tool, i.e. having two interchangeable tools, one providing a shovel function and the other providing a fork function, both suitable for digging the ground. For this purpose, the tool comprises a shaft (1) with one end provided with a cross-piece to form a cross-handle, and the other end provided with means for mounting a digging tool (3-3′), such as a shovel or fork, such that the corresponding shaft (1) comprises at least two sections (1′-1″) which can be removably screwed to one another, the cross-piece of the upper handle comprising a T-shaped connector (5) which can be removably coupled on the upper end of the shaft, and two side elements (7) which can be screwed onto the end of each of the side arms of the T-shaped connector, together forming an upper cross-piece having an oversized length. The interchangeable tool is mounted on the lower end of the shaft (1).

### OBJECT OF THE INVENTION

The present invention relates to a multifunctional digging tool, which is specifically intended for digging the ground and may preferably be used for gardening and similar small-scale tasks, where it is necessary to dig the ground to prepare it and plant flowers, vegetables, etc.

The object of the invention is a dual-function tool, i.e. having two interchangeable tools, one providing a shovel function and the other providing a fork function, both suitable for digging the ground.

### BACKGROUND OF THE INVENTION

As is well-known, digging the ground or land in gardening and related work is carried out using a hoe, which requires the person carrying out the work to do so bent over, i.e. the spine being bent forwards, which entails lower back problems regardless of the high physical exertion needed, since abrupt back and arm movements are necessary when digging with a hoe that are unbearable after a certain period of time, which is not long, as well as the fact that a huge amount of energy is wasted by hitting down in an irregular manner.

Another drawback is that when digging with a hoe, the soil that is moved is immediately trodden on by the person carrying out the operation, dirtying their footwear with soil, as well as the trodden area requiring levelling in order to remove the tracks.

It must also be considered that, when digging with a hoe in areas where there are many plants around, it is very uncomfortable since it is possible to hit branches, regardless of the fact spaces have been left that cannot be accessed to work on the land.

In conclusion, digging with a hoe is an uncomfortable and physically demanding task and, more importantly, it affects the lower back to such an extent that many people find it impossible to dig with a hoe.

### DESCRIPTION OF THE INVENTION

The recommended tool is a digging tool that resolves the aforementioned problems, since the ground can be dug without the person doing the digging having to bend over.

More specifically, a particular feature of the tool of the invention, which may be a shovel or spade or be a fork, both of which are suitable for digging the ground, is that the respective shaft that conventionally ends in a cross-handle, is formed of two sections preferably screwed to one another, while the surface handle defines a cross-piece having an oversized length, and which is preferably formed of a T-shaped connector on the ends of which both side elements that establish a very long cross-section are preferably fastened via threads, while the end of the shaft is also preferably screwed onto the intermediate branch of this connector.

The lower end of the shaft is linked to the tool itself, whether this is a shovel or spade, or a fork, via the coupling of this lower end of the shaft to a collar provided for this purpose on the upper edge of the tool, this coupling being adjustable, in order to vary the length of the tool assembly, and also removable, similarly to the rest of the elements that are included in the tool assembly, the fastening carried out between the tool and the shaft preferably being via through-bolts through holes made in the collar of the tool and in the lower section of the shaft.

A particular feature of the shovel or spade is that it has a trapezoidal configuration, preferably made of steel, and where the bigger and upper base is approximately 19 cm, whilst the smaller base is 16 cm, and the height is 25 cm, the lower edge corresponding to the smaller base, which is sharpened to establish a cutting blade that not only enables it to be driven into the ground in order to carry out gardening tasks, but to cut branches, roots, etc. which may be encountered in the digging operation.

As for the shaft, it has a length of approximately 80 cm, although it may be made with different lengths according to the build or height of the user, while the upper cross-piece or cross-handle is preferably 80 cm long, i.e. both sections being 40 and 40 cm from the centre of the shaft, which benefits the grip and operating action of the tool.

In the case of being a fork, it is also made of steel, with slightly curved prongs and sharpened ends, and in any case, the upper edge, whether it is a shovel or a fork, has a support or thickening that determines a rest for the user's foot, with the aim of being able to push comfortably, easily and efficiently downwards on the tool and achieve the desired digging of the ground.

The particularly long upper grip cross-piece enables users to hold the tool with the hands separated and aligned with the shoulders, this separation thus enabling a lever action to be carried out with minimum effort and exert significant force on the soil, which means that the efficiency of the tool compared to its competitors is significantly greater.

Lastly, it should be noted that, due to the length or height of the tool in the assembly thereof, ground digging work is carried out precisely and accurately, and where the person carrying them out does so in a completely upright position, i.e. standing up, without having to arch the backbone.

### DESCRIPTION OF THE DRAWINGS

To supplement the description provided below, and for the purpose of helping to make the characteristics of the invention more readily understandable, in accordance with a preferred practical exemplary embodiment thereof, said description is accompanied by a set of figures, wherein, by way of illustration and not limitation, the following has been represented:

FIG. 1.—Shows a representation that corresponds to an exploded view in accordance with a side view of the different portions and components that are included in the construction of the multifunction tool, object of the invention, in a preferred embodiment, where the tool itself is a shovel or spade.

FIG. 2.—Shows a detailed side view of the fastening of the shaft to the corresponding tool or shovel that is shown in the previous figure.

FIG. 3.—Shows a perspective view of the fastening means between the shaft and the shovel according to what is shown in the previous figure.

FIG. 4.—Lastly shows a perspective view of the same fastening system, the tool of the previous figure in this case incorporating a fork instead of the shovel.

### PREFERRED EMBODIMENT OF THE INVENTION

As may be seen in the aforementioned figures, the tool of the invention constitutes, as is conventional, a shaft (1), an upper cross-piece (2) or cross-handle for handling the tool, and a shovel (3), or if applicable, a fork (3′), which are interchangeable elements and constitute the tool itself, designed for digging the ground.

For this reason, the shaft (1) preferably constitutes two sections (1′, 1″) that may be coupled to each other via respective complementary threads (4), without rejecting any other type of coupling between the sections (1′, 1″) that constitute the shaft (1), in such a way that this removable coupling enables the sections (1′, 1″) to be separated and stored occupying a minimum length, for its transport in, for example, a suitcase, appropriate bag, etc.

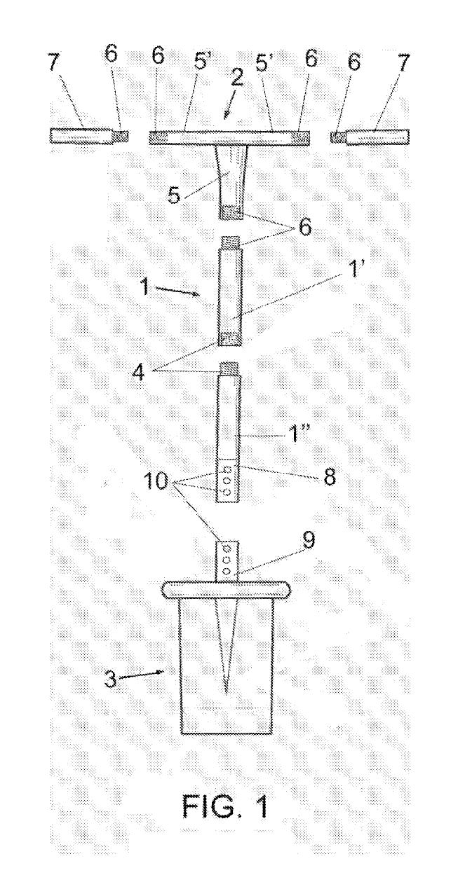

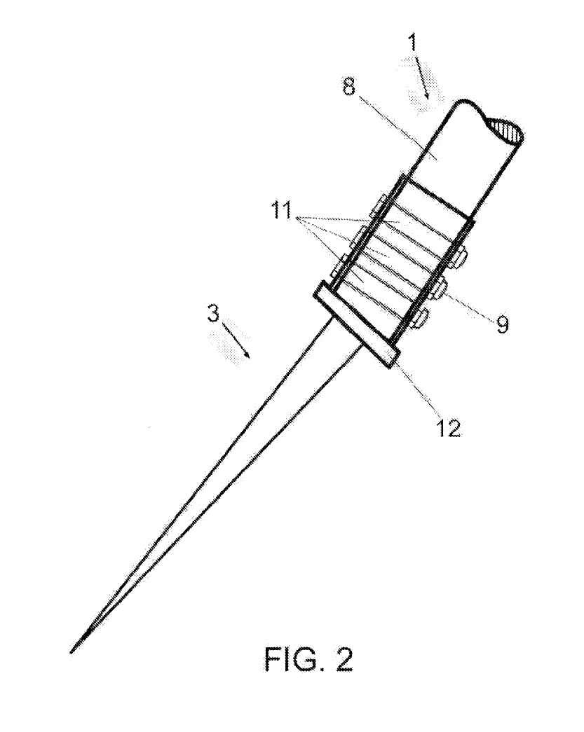

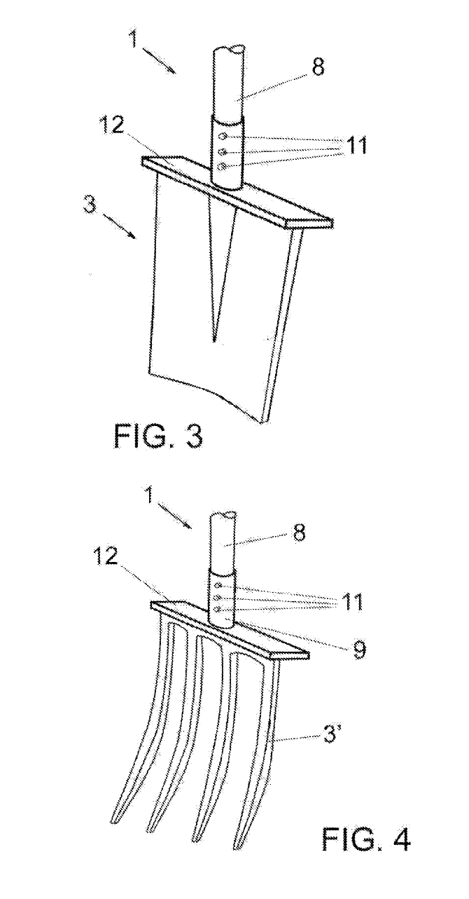

As for the cross-piece or upper cross-handle (2), it preferably constitutes a connector (5) that may be coupled, via complementary threads (6), at the upper end of the shaft (1), this connector having a T-shaped configuration, as seen in FIG. 1, and the side arms (5′) of which have an inner thread (6) in order to screw the respective side elements (7) to one another that have equally been provided with the complementary thread (6) thereof.

In this way, it is achieved that the handle of the tool, in which the cross-piece (2) having an oversized length, as a result of the sections (7) and sides, which may be coupled onto the central connector (5), is significantly long.

As for the coupling of the lower end of the shaft (1) to the corresponding tool (3, 3′), whether it is a shovel or spade in the first case or a fork in the second case, it is carried out by putting a lower section (8) of the shaft (1) into a collar (9) provided for this purpose on the tool (3, 3′), the height of this coupling being adjustable and removable, due to the fact that both the section (8) of the shaft (1) and the collar (9) are affected by holes (10) for corresponding fastening screws (11) to pass through, which enable the length of the shaft assembly, and therefore the tool, to not only be mounted and removed but to adjust the position at a higher or lower height.

Lastly, it should be noted that the digging tool itself, whether it is a shovel or spade (3) or a fork (3′), has a thickening or upper support (12) for resting or pushing with the foot on the tool itself and thus driving it better into the ground.

Both the ends of the prongs that form the fork (3′) and the lower edge of the shovel (3) of the tool are sharpened in order to drive it better into the ground.

Both the shaft and the upper cross-piece of the cross-handle are preferably coated in an insulating material in order to establish electrical insulation and prevent electric shocks in the event of the tool impacting against an electrical cable during digging.

1. A multifunctional digging tool, comprising a shaft with one end provided with a cross-piece to form a cross-handle, and the other end provided with means for mounting a digging tool, wherein the shaft comprises at least two sections which can be removably screwed to one another, the cross-piece of the upper handle being formed of a T-shaped connector which can be removably coupled on the upper end of the shaft, and two side elements which can be screwed onto the end of each of the side arms of the T-shaped connector, together establishing an upper cross-piece having an oversized length; with the particular feature that the shovel or spade that is interchangeable with the fork is mounted on the lower end of the shaft.

2. The multifunctional digging tool, according to claim 1, wherein both the digging tool is made of metal and has a thickening on the upper edge, which determines a rest for the user's foot.

3. The multifunctional digging tool, according to claim 1, wherein the digging tool has an isosceles trapezoid configuration, in which the edge corresponding to the lower and smaller base is sharpened in order to define a cutting and driving edge in the ground.

4. The multifunctional digging tool, according to claim 1, wherein the length of the shaft is approximately 80 cm, and in accordance with the height of the user using the tool, while the dimensions of the shovel correspond to approximately 19 cm at the upper and bigger base, 16 cm at the lower and smaller base, and 25 cm high, each one of the side elements of the upper cross-piece of the handle being equipped with a preferable length of approximately 40 cm.

5. The multifunctional digging tool according to claim 1, wherein the digging tool is a shovel, fork, or spade.

6. The multifunctional digging tool according to claim 2, wherein the digging tool is made of steel.
